(19) United States
(12) Patent Application Publication
(10) Pub. No.: US 2013/0137814 A1
(43) Pub. Date: May 30, 2013

(54) RUBBER COMPOSITION

(71) Applicant: Sumitomo Chemical Company, Limited, Tokyo (JP)

(72) Inventor: Sadayuki NAKANO, Ichihara-shi (JP)

(73) Assignee: SUMITOMO CHEMICAL COMPANY, LIMITED, Tokyo (JP)

(21) Appl. No.: 13/680,702

(22) Filed: Nov. 19, 2012

(30) Foreign Application Priority Data
Nov. 25, 2011 (JP) 2011-257156

(51) Int. Cl. C08L 33/10

(52) U.S. Cl. CPC C08L 33/10
USPC 524/523

(57) ABSTRACT

The present invention relates to a rubber composition comprising (A) an ethylene-α-olefin-based copolymer rubber, (B) a softening agent, and (C) an alkyl(meth)acrylate-based polymer.

### BACKGROUND OF THE INVENTION

1. Field of the Invention

The present invention relates to an ethylene-α-olefin-based copolymer rubber composition.

2. Related Background Art

For parts around engines and the parts of drivelines for automobiles, the parts of flooring, and parts mounted in the vicinity of the compressors of refrigerators, rubber products, such as engine mounts, muffler hangers, vibration proof pads, and vibration proof mats, the so-called vibration proof rubbers, are used in order to prevent or reduce the transmission of vibration.

As such vibration proof rubbers, moldings produced using ethylene-α-olefin-based copolymer rubbers are known. For example, in JP 03-227343 A and JP 04-323236 A are proposed vibration proof rubbers comprising vulcanized rubbers prepared by vulcanizing a rubber composition containing an ethylene-propylene-diene copolymer rubber, carbon black, and a process oil.

### SUMMARY OF THE INVENTION

However, vibration proof rubbers with further improved vibration proofness have been demanded, and proposals of new ethylene-α-olefin-based copolymer rubber compositions for vibration proof rubber materials have been required.

Under such circumstances, problems that the present invention is to solve are to provide an ethylene-α-olefin-based copolymer rubber composition suitably used for the production of a vibration proof rubber, and further to provide a vulcanized rubber composition prepared by vulcanizing the rubber composition, and a vibration proof rubber having improved vibration proofness that comprises the vulcanized rubber composition.

A first aspect of the present invention relates to a rubber composition comprising the following components (A), (B) and (C):
(A) an ethylene-α-olefin-based copolymer rubber;
(B) a softening agent;
(C) an alkyl(meth)acrylate-based polymer.

A second aspect of the present invention relates to a vulcanized rubber composition obtained by vulcanizing the above rubber composition.

A third aspect of the present invention relates to a vibration proof rubber comprising the above vulcanized rubber composition.

According to the present invention, it is possible to provide a rubber composition that is an ethylene-α-olefin-based copolymer rubber composition and is suitably used for a vibration proof rubber. In addition, it is possible to provide a vulcanized rubber composition prepared by vulcanizing the rubber composition, and a vibration proof rubber comprising the vulcanized rubber composition.

### DESCRIPTION OF THE PREFERRED EMBODIMENTS

In the present invention, the ethylene-α-olefin-based copolymer rubber is one or more rubbers selected from ethylene-α-olefin copolymer rubbers and ethylene-α-olefin-nonconjugated polyene copolymer rubbers. The α-olefin is preferably an α-olefin having 3 to 20 carbon atoms, and examples of the α-olefin include propylene, 1-butene, 1-pentene, 1-hexene, 4-methyl-1-pentene, 1-octene and 1-decene. More preferred α-olefins are propylene and 1-butene.

Examples of the nonconjugated polyene include chain nonconjugated dienes, such as 1,4-hexadiene, 1,6-octadiene, 2-methyl-1,5-hexadiene, 6-methyl-1,5-heptadiene and 7-methyl-1,6-octadiene; cyclic nonconjugated dienes, such as cyclohexadiene, dicyclopentadiene, methyltetraindene, 5-vinyl-2-norbornene, 5-(2-propenyl)-2-norbornene, 5-(3-butenyl)-2-norbornene, 5-(4-pentenyl)-2-norbornene, 5-(5-hexenyl)-2-norbornene, 5-(5-heptenyl)-2-norbornene, 5-(7-octenyl)-2-norbornene, 5-methylene-2-norbornene, 5-ethylidene-2-norbornene and 6-chloromethyl-5-isopropenyl-2-norbornene; and trienes, such as 2,3-diisopropylidene-5-norbornene, 2-ethylidene-3-isopropylidene-5-norbornene, 2-propenyl-2,2-norbornadiene, 1,3,7-octatriene, 1,4,9-decatriene, 6,10-dimethyl-1,5,9-undecatriene, 5,9-dimethyl-1,4,8-decatriene, 4-ethylidene-8-methyl-1,7-nonadiene, 13-ethyl-9-methyl-1,9,12-pentadecatriene, 8,14,16-trimethyl-1,7,14-hexadecatriene and 4-ethylidene-12-methyl-1,11-pentadecadiene. One or more of these are used. Preferred nonconjugated polyenes are 5-ethylidene-2-norbornene and/or dicyclopentadiene are preferred.

The weight ratio of an ethylene unit amount to an α-olefin unit amount (the amount of ethylene units/the amount of α-olefin units) in the ethylene-α-olefin-based copolymer rubber is preferably 85/15 or less, more preferably 80/20 or less, from the viewpoint of the vibration proofness of a product. The weight ratio is preferably 40/60 or more, more preferably 45/55 or more, in order to increase durability.

The Mooney viscosity (ML (1+4) 150° C.) of the ethylene-α-olefin-based copolymer rubber is preferably 50 or more, more preferably 70 or more, and further preferably 100 or more, from the viewpoint of the durability of a product. The Mooney viscosity is measured by the method described in JIS K6300-1 (2001).

In view of the durability of a product, the amount of nonconjugated polyene unit amount in the ethylene-α-olefin-nonconjugated polyene copolymer rubber is preferably 5 or more, more preferably 8 or more, expressed by an iodine value-equivalent value. In addition, the amount of nonconjugated polyene units is preferably 36 or less, more preferably 30 or less, from the viewpoint of the vibration proofness of a product. The iodine value-equivalent value is obtained by measuring the content of double bonds derived from the nonconjugated polyene units by infrared spectroscopy, and converting the content to an iodine value. When the nonconjugated polyene is 5-ethylidene-2-norbornene, an infrared absorption peak at 1688 cm⁻¹ is used for the measurement of the content of double bonds by infrared spectroscopy.

Ethylene-α-olefin copolymer rubbers and/or ethylene-α-olefin-nonconjugated polyene copolymer rubbers are preferred as the ethylene-α-olefin-based copolymer rubber. Examples of the ethylene-α-olefin copolymer rubbers include an ethylene-propylene copolymer rubber, an ethylene-1-butene copolymer rubber, an ethylene-1-hexene copolymer rubber, an ethylene-1-octene copolymer rubber, an ethylene-propylene-1-butene copolymer rubber and an ethylene-propylene-1-hexene copolymer rubber. Examples of the ethylene-α-olefin-nonconjugated polyene copolymer rubbers include an ethylene-propylene-5-ethylidene-2-norbornene copolymer rubber, an ethylene-propylene-dicyclopentadiene copolymer rubber, an ethylene-propylene-5-vinyl-2-norbornene copolymer rubber, an ethylene-1-butene-5-ethylidene-2-norbornene copolymer rubber, an ethylene-1-butene-dicyclopentadiene copolymer rubber and an ethylene-1-butene-5-vinyl-2-norbornene copolymer rubber. One or more of these rubbers are used. In addition, when two or more rubbers are used, the weight ratio of the ethylene unit amount to the α-olefin unit amount, the Mooney viscosity, and the iodine value described above are values for the whole of the rubbers.

The ethylene-α-olefin-based copolymer rubber is produced by a publicly known method. For example, the ethylene-α-olefin-based copolymer rubber is produced by copolymerizing ethylene and an α-olefin, or copolymerizing ethylene, an α-olefin and a nonconjugated polyene, using a polymerization catalyst such as a titanium-based catalyst, a vanadium-based catalyst or a metallocene-based catalyst.

In the present invention, the softening agent is selected from petroleum-based softening agents, coal tar-based softening agents, fatty oil-based softening agents and waxes.

Examples of the petroleum-based softening agents include mineral oils, paraffins, liquid paraffins, petroleum asphalts and petroleum jellies. Examples of the coal tar-based softening agents include coal tars and coal tar pitches. Examples of the fatty oil-based softening agents include castor oil, linseed oil, rape seed oil and coconut oil. Examples of the waxes include waxes such as tall oil, factice, beeswax, carnauba wax and lanolin. One or more of these softening agents are used.

Mineral oils are preferred as the softening agent, and examples of the mineral oils include paraffin-based process oils, naphthene-based process oils and aromatic process oils, and the mineral oils are more preferably paraffin-based process oils. Examples of commercial paraffin-based process oils include “Diana PW-32”, “Diana PW-90”, “Diana PW-150”, “Diana PW-380”, “Diana PS-32”, “Diana PS-90” and “Diana PS-430” manufactured by Idemitsu Kosan Co., Ltd., “COSMO NEUTRAL 100”, “COSMO NEUTRAL 150”, “COSMO NEUTRAL 350”, “COSMO NEUTRAL 500” and “COSMO NEUTRAL 700” manufactured by COSMO OIL LUBRICANTS CO., LTD., and “SUNPAR 110”, “SUNPAR 115”, “SUNPAR 120”, “SUNPAR 130”, “SUNPAR 150”, “SUNPAR 2100” and “SUNPAR 2280” manufactured by Japan Sun Oil Company, Ltd. One or more of these are used.

The kinematic viscosity of the process oils at 40° C. is preferably 20 to 450 mm²/s, more preferably 20 to 400 mm²/s, and further preferably 20 to 150 mm²/s. The kinematic viscosity is measured according to JIS K2283 (2000).

The mineral oil may be added to the ethylene-α-olefin-based copolymer rubber as an extender oil in the step of producing the ethylene-α-olefin-based copolymer rubber. The mineral oil to be used as an extender oil is preferably a paraffin-based process oil.

The content of the softening agent in a rubber composition is preferably 1 part by weight or more, more preferably 10 parts by weight or more, and more preferably 20 parts by weight or more, per 100 parts by weight of the ethylene-α-olefin-based copolymer rubber from the viewpoint of the processability of the rubber composition. In addition, the content is preferably 300 parts by weight or less, more preferably 250 parts by weight or less, and more preferably 200 parts by weight or less, from the viewpoint of the vibration proofness of a product.

The alkyl(meth)acrylate-based polymer in the present invention is a polymer having an alkyl methacrylate unit or an alkyl acrylate unit. In addition, the alkyl(meth)acrylate means an alkyl methacrylate or an alkyl acrylate. The alkyl methacrylate is preferably an alkyl methacrylate in which the “alkyl” moiety of the alkyl methacrylate is an alkyl group having 1 to 30 carbon atoms. Examples of the alkyl methacrylate include alkyl methacrylates in which the “alkyl” moiety of the alkyl methacrylate is an alkyl group having 1 to 10 carbon atoms, such as methyl methacrylate, propyl methacrylate, hexyl methacrylate, heptyl methacrylate and nonyl methacrylate; alkyl methacrylates in which the “alkyl” moiety of the alkyl methacrylate is an alkyl group having 11 to 20 carbon atoms, such as undecyl methacrylate, dodecyl methacrylate, tridecyl methacrylate, pentadecyl methacrylate, heptadecyl methacrylate and stearyl methacrylate; and alkyl methacrylates in which the “alkyl” moiety of the alkyl methacrylate is an alkyl group having 21 to 30 carbon atoms, such as henicosa methacrylate, docosa methacrylate and triaconta methacrylate. One or more of these are used. The alkyl(meth)acrylate-based polymer may have an alkyl acrylate unit. The alkyl acrylate is preferably an alkyl acrylate in which the “alkyl” moiety of the alkyl acrylate is an alkyl group having 1 to 30 carbon atoms. Examples of the alkyl acrylate include alkyl acrylates in which the “alkyl” moiety of the alkyl acrylate is an alkyl group having 1 to 10 carbon atoms, such as methyl acrylate, propyl acrylate, hexyl acrylate, heptyl acrylate and nonyl acrylate; alkyl acrylates in which the “alkyl” moiety of the alkyl acrylate is an alkyl group having 11 to 20 carbon atoms, such as undecyl acrylate, dodecyl acrylate, tridecyl acrylate, pentadecyl acrylate, heptadecyl acrylate and stearyl acrylate; and alkyl acrylates in which the “alkyl” moiety of the alkyl acrylate is an alkyl group having 21 to 30 carbon atoms, such as henicosa acrylate, docosa acrylate and triaconta acrylate. One or more of these are used.

Examples of the alkyl(meth)acrylate-based polymer include polymethyl methacrylate, polypropyl methacrylate, polyhexyl methacrylate, polyheptyl methacrylate, polynonyl methacrylate, polyundecyl methacrylate, polydodecyl methacrylate, polytridecyl methacrylate, polypentadecyl methacrylate, polyheptadecyl methacrylate, polystearyl methacrylate, polyhenicosa methacrylate, polydocosa methacrylate, polytriaconta methacrylate, polymethyl acrylate, polypropyl acrylate, polyhexyl acrylate, polyheptyl acrylate, polynonyl acrylate, polyundecyl acrylate, polydodecyl acrylate, polytridecyl acrylate, polypentadecyl acrylate, polyheptadecyl acrylate, polystearyl acrylate, polyhenicosa acrylate, polydocosa acrylate and polytriaconta acrylate. Examples of commercially available alkyl (meth)acrylate-based polymers include “ACLUBE P-2320”, “ACLUBE 132”, “ACLUBE 136”, “ACLUBE 146”, “ACLUBE 148” and “ACLUBE 160” manufactured by Sanyo Chemical Industries, Ltd., and “LUBRAN 141”, “LUBRAN 162”, “LUBRAN 165” and “LUBRAN 171” manufactured by TOHO Chemical Industry Co., Ltd. One or more of these are used.

In the alkyl(meth)acrylate-based polymer, the “alkyl” moiety is preferably an alkyl group having 1 to 30 carbon atoms, more preferably an alkyl group having 4 to 25 carbon atoms, and further preferably an alkyl group having 10 to 20 carbon atoms, from the viewpoint of the vibration proofness of a product.

The weight-average molecular weight (polystyrene-equivalent value) of the alkyl(meth)acrylate-based polymer is generally 10,000 to 1,300,000. The weight-average molecular weight is determined by gel permeation chromatography.

The blending amount of the alkyl(meth)acrylate-based polymer is preferably 0.05 parts by weight or more, more preferably 0.1 parts by weight or more, per 100 parts by weight of the softening agent from the viewpoint of the vibration proofness of a product. In addition, from the same viewpoint, the blending amount is preferably 10 parts by weight or less, 8 parts by weight or less, and 6 parts by weight or less.

When the alkyl(meth)acrylate-based polymer is blended into the ethylene-α-olefin-based copolymer rubber, it is preferred, in order to obtain a rubber composition having higher vibration proofness, to prepare a mixture of the alkyl(meth)acrylate-based polymer and the softening agent in advance and then blend the mixture into the ethylene-α-olefin-based copolymer rubber. The kinematic viscosity of the mixture of the alkyl(meth)acrylate-based polymer and the softening agent at 100° C. is preferably 50 to 700 mm²/s. The kinematic viscosity is measured according to JIS K2283 (2000). In addition, the alkyl(meth)acrylate-based polymer may be added to the ethylene-α-olefin-based copolymer rubber together with an extender oil in the step of producing an oil-extended ethylene-α-olefin-based copolymer rubber.

The rubber composition of the present invention may contain an organic polymer other than ethylene-α-olefin-based copolymer rubbers; and additives such as an antioxidant, carbon black, a white filler and a processing aid, as required.

Examples of the organic polymer include natural rubbers, styrene-butadiene rubbers, chloroprene rubbers, acrylonitrile-butadiene rubbers, acrylic rubbers, butadiene rubbers, liquid polybutadiene and modified liquid polybutadiene. One or more of these are used.

Examples of the antioxidant include aromatic secondary amine-based stabilizers, such as phenylnaphthylamine and N,N′-di-2-naphthylphenylenediamine; phenol-based stabilizers, such as dibutylhydroxytoluene tetrakis[methylene(3,5-di-tert-butyl-4-hydroxy)hydrocinnamate]methane; thioether-based stabilizers, such as bis[2-methyl-4-(3-n-alkylthiopropionyloxy)-5-tert-butylphenyl]sulfide; and carbamate-based stabilizers, such as nickel dibutyldithiocarbamate. One or more of these are used. When the antioxidant is blended, the content of the antioxidant is preferably 0.1 to 10 parts by weight per 100 parts by weight of the ethylene-α-olefin-based copolymer rubber.

Examples of the carbon black include an HAF grade, an MAF grade, an FEF grade, a GPF grade and an SRF grade. One or more of these are used. When the carbon black is blended, the content of the carbon black is preferably 2 to 150 parts by weight, more preferably 10 to 100 parts by weight, and further preferably 10 to 80 parts by weight, per 100 parts by weight of the ethylene-α-olefin-based copolymer rubber.

Examples of the white filler include silicates, such as silica, aluminum silicate, and talc; carbonates such as calcium carbonate and magnesium carbonate; metal oxides such as zinc oxide, magnesium oxide, calcium oxide, aluminum oxide and titanium oxide; and surface-treated fillers in which the surfaces of these are treated with a coupling agent or the like. One or more of these are used. When the white filler is blended, the content of the white filler is preferably 2 to 150 parts by weight per 100 parts by weight of the ethylene-α-olefin-based copolymer rubber.

Examples of the processing aid include fatty acids such as oleic acid, palmitic acid and stearic acid; fatty acid metal salts such as zinc stearate and calcium stearate; fatty acid esters; and glycols such as ethylene glycol and polyethylene glycol. One or more of these are used. When the processing aid is blended, the content of the processing aid is preferably 0.2 to 10 parts by weight per 100 parts by weight of the ethylene-α-olefin-based copolymer rubber.

The rubber composition of the present invention can be prepared by kneading the ethylene-α-olefin-based copolymer rubber, the softening agent, and the alkyl(meth)acrylate-based polymer, and the organic polymer and/or additives blended, as required, by a publicly known kneading machine. Examples of the kneading machine include Banbury mixers, kneaders, and rolls.

As a method for producing the rubber composition, it is preferred to feed the following components (a) and (b), as well as the following component (c) when required, into a kneading machine and knead these components:

(a) an oil-extended ethylene-α-olefin-based copolymer rubber;

(b) a mixed liquid of an alkyl(meth)acrylate-based polymer and a softening agent;

(c) a softening agent.

The amount of the extender oil of (a) the oil-extended ethylene-α-olefin-based copolymer rubber is preferably 10 to 100 parts by weight per 100 parts by weight of the ethylene-α-olefin-based copolymer rubber in (a) the oil-extended ethylene-α-olefin-based copolymer rubber.

The extender oil of (a) the oil-extended ethylene-α-olefin-based copolymer rubber is preferably a mineral oil, more preferably a paraffin-based process oil.

The Mooney viscosity (ML (1+4) 150° C.) of (a) the oil-extended ethylene-α-olefin-based copolymer rubber is preferably 20 to 100.

The softening agent to be used for the preparation of (b) the mixed liquid of the alkyl(meth)acrylate-based polymer and the softening agent is preferably a mineral oil, more preferably a paraffin-based process oil.

The content of the alkyl(meth)acrylate-based polymer in (b) the mixed liquid of the alkyl(meth)acrylate-based polymer and the softening agent is preferably 0.1 to 20 parts by weight, more preferably 0.2 to 10 parts by weight, per 100 parts by weight of the softening agent in the mixed liquid.

The amount of (b) the mixed liquid of the alkyl(meth)acrylate-based polymer and the softening agent to be fed, expressed by the amount of the softening agent in the mixed liquid, is preferably 1 to 300 parts by weight per 100 parts by weight of the ethylene-α-olefin-based copolymer rubber in (a) the oil-extended ethylene-α-olefin-based copolymer rubber.

The amount of (c) the softening agent to be fed is preferably 0 to 180 parts by weight per 100 parts by weight of the ethylene-α-olefin-based copolymer rubber in (a) the oil-extended ethylene-α-olefin-based copolymer rubber.

The kneading temperature of the component (a) and the component (b), and that of the component (a), the component (b), and the component (c) are preferably 40 to 170° C., and the kneading time is preferably 1 to 15 minutes.

The rubber composition of the present invention is excellent in processability. In addition, a vulcanized rubber composition obtained by vulcanizing the rubber composition is excellent in vibration proofness as described later.

By vulcanizing the rubber composition of the present invention, a vulcanized rubber composition can be prepared. Examples of the method for preparing a vulcanized rubber composition include a method that comprises blending a vulcanizing agent, and a vulcanizing coagent and/or a vulcanizing accelerator as required, into the rubber composition, and heat-treating the rubber composition at a temperature of 120° C. or more, preferably 130 to 250° C., and more preferably 140 to 200° C., for 1 to 60 minutes, preferably 1 to 30 minutes, to vulcanize the rubber composition in which the vulcanizing agent, etc. have been blended. For the blending of the vulcanizing agent, etc., publicly known kneading machines, such as Banbury mixers, kneaders, and rolls, can be used. In addition, for the heat treatment, ovens, compression molding machines, injection molding machines, transfer molding machines, and the like can be used.

Examples of the vulcanizing agent include sulfur and organic peroxides. Examples of the organic peroxides include dicumyl peroxide, 2,5-dimethyl-2,5-di(tert-butylperoxy)hexane, 2,5-dimethyl-2,5-di(benzoylperoxy)hexane, 2,5-dimethyl-2,5-(tert-butylperoxy)hexyne-3, di-tert-butyl peroxide, ditertiary butyl peroxide-3,3,5-trimethylcyclohexane and tert-butyl hydroperoxide. The organic peroxides are preferably dicumyl peroxide, di-tert-butyl peroxide, and di-tert-butyl peroxide-3,3,5-trimethylcyclohexane. One or more of these are used. When the organic peroxide is used, the amount of the organic peroxide to be used is preferably 0.1 to 15 parts by weight per 100 parts by weight of the ethylene-α-olefin-based copolymer rubber. In addition, when sulfur is used, the amount of sulfur to be used is preferably 0.05 to 5 parts by weight per 100 parts by weight of the ethylene-α-olefin-based copolymer rubber.

When the organic peroxide is used for the vulcanizing agent, a vulcanizing coagent can be used as required. Examples of the vulcanizing coagent include triallyl isocyanurate, N,N′-m-phenylenebismaleimide, methacrylic acid, methyl methacrylate, ethyl methacrylate, propyl methacrylate, isopropyl methacrylate, n-butyl methacrylate, isobutyl methacrylate, sec-butyl methacrylate, tert-butyl methacrylate, 2-ethylhexyl methacrylate, cyclohexyl methacrylate, isodecyl methacrylate, lauryl methacrylate, tridecyl methacrylate, stearyl methacrylate, 2-hydroxyethyl methacrylate, hydroxypropyl methacrylate, polyethylene glycol monomethacrylate, polypropylene glycol monomethacrylate, 2-ethoxyethyl methacrylate, tetrahydrofurfuryl methacrylate, allyl methacrylate, glycidyl methacrylate, benzyl methacrylate, dimethylaminoethyl methacrylate, diethylaminoethyl methacrylate, methacryloxyethyl phosphate, 1,4-butanediol diacrylate, ethylene glycol dimethacrylate, 1,3-butylene glycol dimethacrylate, neopentyl glycol dimethacrylate, 1,6-hexanediol dimethacrylate, diethylene glycol dimethacrylate, triethylene glycol dimethacrylate, polyethylene glycol dimethacrylate, dipropylene glycol dimethacrylate, polypropylene glycol dimethacrylate, trimethylolethane trimethacrylate, trimethylolpropane trimethacrylate, allyl glycidyl ether, N-methylolmethacrylamide, 2,2-bis(4-methacryloxypolyethoxyphenyl)propane, aluminum methacrylate, zinc methacrylate, calcium methacrylate, magnesium methacrylate and 3-chloro-2-hydroxypropyl methacrylate. One or more of these are used. When the vulcanizing coagent is used, the amount of the vulcanizing coagent to be used is preferably 0.05 to 15 parts by weight per 100 parts by weight of the ethylene-α-olefin-based copolymer rubber.

Examples of the vulcanizing accelerator include 4,4′-dithiodimorpholine, tetramethylthiuram monosulfide, tetramethylthiuram disulfide, tetraethylthiuram disulfide, tetrabutylthiuram disulfide, dipentamethylenethiuram monosulfide, dipentamethylenethiuram disulfide, dipentamethylenethiuram tetrasulfide, N,N′-dimethyl-N,N′-diphenylthiuram disulfide, N,N′-dioctadecyl-N,N′-diisopropylthiuram disulfide, N-cyclohexyl-2-benzothiazole-sulfenamide, N-oxydiethylene-2-benzothiazole-sulfenamide, N,N-diisopropyl-2-benzothiazolesulfenamide, 2-mercaptobenzothiazole, 2-(2,4-dinitrophenyl)mercaptobenzothiazole, 2-(2,6-diethyl-4-morpholinothio)benzothiazole, dibenzothiazyl-disulfide, diphenylguanidine, triphenylguanidine, diorthotolylguanidine, orthotolyl-bi-guanide, diphenylguanidine-phthalate, an acetaldehyde-aniline reaction product, a butylaldehyde-aniline condensate, hexamethylenetetramine, acetaldehyde ammonia, 2-mercaptoimidazoline, thiocarbanilide, diethylthiourea, dibutylthiourea, trimethylthiourea, diorthotolylthiourea, zinc dimethyldithiocarbamate, zinc diethylthiocarbamate, zinc di-n-butyldithiocarbamate, zinc ethylphenyldithiocarbamate, zinc butylphenyldithiocarbamate, sodium dimethyldithiocarbamate, selenium dimethyldithiocarbamate, tellurium diethyldithiocarbamate, zinc dibutylxanthate, and ethylenethiourea. One or more of these are used. When the vulcanizing accelerator is used, the amount of the vulcanizing accelerator to be used is preferably 0.05 to 20 parts by weight per 100 parts by weight of the ethylene-α-olefin-based copolymer rubber.

The vulcanized rubber composition is preferably used as a vibration proof rubber. Examples of the vibration proof rubber include vibration proof pads; and vibration proof mats to be used for the members of engine mounts, muffler hangers, strut mounts, torsional dampers, change lever mounts, torsion rubbers for clutches, centering bushes, tube dampers, torque bushes, suspension bushes, body mounts, cab mounts, member mounts, strut bar cushions, tension rod bushes, arm bushes, lowering bushes, radiator supports, damper pulleys, rack mounts, refrigerators, and the like.

### EXAMPLES

The present invention will be described below by Examples.

### Example 1

30 Parts by weight of a softening agent (a paraffin-based process oil manufactured by COSMO OIL LUBRICANTS CO., LTD., trade name: COSMO NEUTRAL 700) and 0.7 parts by weight of an alkyl(meth)acrylate-based polymer (polymethyl acrylate, weight-average molecular weight: 42000) were mixed to prepare a mixed liquid.

Next, 140 parts by weight of an oil-extended ethylene-α-olefin-nonconjugated diene copolymer rubber [100 parts by weight of an ethylene-propylene-5-ethylidene-2-norbornene copolymer rubber (ethylene unit amount/propylene unit amount (weight ratio)=75/25, 5-ethylidene-2-norbornene unit amount=an iodine value-equivalent value of 14) was oil-extended with 40 parts by weight of a paraffin-based process oil (kinematic viscosity (40° C.)=95 mm²/s); Mooney viscosity (ML (1+4) 150° C.)=73], 70 parts by weight of carbon black, 5 parts by weight of zinc oxide, 1 part by weight of stearic acid, and 30.7 parts by weight of the above mixed liquid were kneaded at a rotor speed of 60 rpm for 5 minutes by a Banbury mixer adjusted to a temperature of 80° C.

The obtained kneaded material, 1.875 parts by weight of zinc di-n-butyldithiocarbamate (trade name: Rhenogran ZDBC-80, manufactured by Rhein Chemie), 0.625 parts by weight of tetramethylthiuram disulfide (trade name: Rhenogran TMTD-80, manufactured by Rhein Chemie), 1.875 parts by weight of N-cyclohexylbenzothiazolesulfenamide (trade name: Rhenogran CBS-80, manufactured by Rhein Chemie), 1.25 parts by weight of 4,4′-dithiodimorpholine (trade name: NOCMASTER R80E, manufactured by OUCHI SHINKO CHEMICAL INDUSTRIAL CO., LTD), and 0.5 parts by weight of sulfur were kneaded at a roll temperature of 50° C. using an open roll to obtain a rubber composition.

The obtained rubber composition was vulcanized by a compression molding machine at a temperature of 160° C. and a pressure of 10 MPa for 20 minutes to obtain a 2 mm thick vulcanized sheet of a vulcanized rubber composition.

A strip-shaped No. 1 type test piece prescribed in JIS K6254-1993 was cut from the vulcanized sheet. Next, using the test piece, a static shear modulus was measured by a TENSILON universal tensile tester (RTC-1210A manufactured by A&D Company, Limited) under the test conditions of an atmosphere temperature of 23° C. and a tensile speed of 50 mm/min according to JIS K6254-1993 “5. Low Deformation Tensile Test.” A value which was three times the static shear modulus was taken as a static modulus.

A strip-shaped test piece having a width of 5 mm and an overall length of 50 mm was cut from the vulcanized sheet. Next, using the test piece, a dynamic modulus was measured by a VR-7110 automatic viscoelasticity analyzer (manufactured by Ueshima Seisakusho Co., Ltd.) under the conditions of an atmosphere temperature of 23° C., a vibration frequency of 100 Hz, an initial elongation of 5%, and an amplitude of ±0.1%. A value obtained by dividing the above-described dynamic modulus by the above-described static modulus was defined as a dynamic multiplication. As the dynamic multiplication becomes lower, vibration proofness becomes more excellent. The measurement result of the dynamic multiplication is shown in Table 1.

### Example 2

Operations were performed as in Example 1 except that 0.7 parts by weight of an alkyl(meth)acrylate-based polymer (polyhexyl acrylate, weight-average molecular weight: 41000) was used. The measurement result of dynamic multiplication is shown in Table 1.

### Example 3

Operations were performed as in Example 1 except that 0.7 parts by weight of an alkyl(meth)acrylate-based polymer (polydodecyl acrylate, weight-average molecular weight: 99000) was used. The measurement result of dynamic multiplication is shown in Table 1.

### Example 4

Operations were performed as in Example 1 except that 0.7 parts by weight of an alkyl(meth)acrylate-based polymer (polystearyl acrylate, weight-average molecular weight: 588000) was used. The measurement result of dynamic multiplication is shown in Table 1.

### Example 5

Operations were performed as in Example 1 except that 1.0 part by weight of an alkyl(meth)acrylate-based polymer-mineral oil mixture (trade name: ACLUBE 132, manufactured by Sanyo Chemical Industries, Ltd., alkyl(meth)acrylate-based polymer content: about 70% by weight) was used instead of the alkyl(meth)acrylate-based polymer. The measurement result of dynamic multiplication is shown in Table 1.

### Comparative Example 1

Operations were performed as in Example 1 except that no alkyl(meth)acrylate-based polymer was used. The measurement result of dynamic multiplication is shown in Table 1.

TABLE 1

| Evaluation | Exam- | Exam- | Exam- | Exam- | Exam- | Comparative |
|---|---|---|---|---|---|---|
| result | ple 1 | ple 2 | ple 3 | ple 4 | ple 5 | Example 1 |
| Dynamic | 1.96 | 1.89 | 1.85 | 1.83 | 1.87 | 2.02 |
| multi- | | | | | | |
| plication | | | | | | |

What is claimed is:

1. A rubber composition comprising the following components (A), (B) and (C):
(A) an ethylene-α-olefin-based copolymer rubber;
(B) a softening agent;
(C) an alkyl(meth)acrylate-based polymer.

2. The rubber composition according to claim 1, wherein the content of the component (B) is 1 to 300 parts by weight per 100 parts by weight of the component (A), and the content of the component (C) is 0.05 to 10 parts by weight per 100 parts by weight of the component (B).

3. The rubber composition according to claim 1, further comprising 2 to 150 parts by weight of the following component (D) per 100 parts by weight of the component (A):
(D) carbon black.

4. The rubber composition according to claim 1, wherein the component (B) is a paraffin-based process oil, and the kinematic viscosity of the paraffin-based process oil at 40° C. is 20 to 450 mm²/s.

5. A vulcanized rubber composition obtained by vulcanizing the rubber composition according to claim 1.

6. A vibration proof rubber comprising the vulcanized rubber composition according to claim 5.

7. A method for producing the rubber composition according to claim 1, comprising:
feeding the following components (a) and (b), as well as the following component (c) when required into a kneading machine,
(a) an oil-extended ethylene-α-olefin-based copolymer rubber,
(b) a mixed liquid of an alkyl(meth)acrylate-based polymer and a softening agent,
(c) a softening agent; and
kneading the components.
